(19) United States
(12) Patent Application Publication
(10) Pub. No.: US 2007/0096481 A1
(43) Pub. Date: May 3, 2007

(54) Door retaining device

(76) Inventor: Ching Yun Huang, Sengang Hsiang (TW)

Correspondence Address: CHARLES E. BAXLEY, ESQ., 90 JOHN STREET, THIRD FLOOR, NEW YORK, NY, 10038, US

(21) Appl. No.: 11/264,840

(22) Filed: Nov. 1, 2005

(51) Int. Cl. E05C 17/44

(52) U.S. Cl. 292/342

(57) ABSTRACT

A door retaining device includes a hook member, a housing, a latch rotatably attached to the housing, and a rotating device for rotating the latch relative to the housing to actuate the latch to selectively engage with the hook member and to stably anchor and secure the hook member to the housing when the hook member is moved toward and depressed against the housing, or to selectively disengage the latch from the hook member and to position the latch in disengagement from the hook member when the hook member is moved toward and depressed against the housing again. A stem is slidably received in the housing and coupled to the latch for rotating the latch when the stem is slid and moved relative to the housing.

### BACKGROUND OF THE INVENTION

1. Field of the Invention

The present invention relates to a door retaining device, and more particularly to a door retaining device for releaseably attaching or anchoring or positioning a door panel to a wall member, and having a structure for allowing the door panel to be easily anchored or positioned to the wall member and to be easily disengaged or released from the wall member without bending down the users' bodies and without hand contacting or engaging with latches and hook members.

2. Description of the Prior Art

Typical door panels are required to be attached or anchored or positioned or retained to a wall member with various kinds of retaining or locking or latching devices, in order to retain and to position the door panels at an open position relative to the wall member.

For example, the typical retaining or locking or latching devices may comprise a magnet attached to the door panel, and a magnetic attractable member attached to the wall member, for engaging with or for acting with the magnet that is attached to the door panel, and for releaseably retaining or locking or latching the door panels to the wall member at the open position.

However, the magnets and the magnetic attractable members may be become failure particularly in the wet or humidity environment in such as the bathrooms. In addition, the door panels may not be stably retained or locked or latched to the wall member with the magnets and the magnetic attractable members, and may have a good chance to be released or disengaged from the wall member inadvertently.

The present invention has arisen to mitigate and/or obviate the afore-described disadvantages of the conventional door retaining devices.

### SUMMARY OF THE INVENTION

The primary objective of the present invention is to provide a door retaining device for releaseably attaching or anchoring or positioning a door panel to a wall member, and having a structure for allowing the door panel to be easily anchored or positioned to the wall member and to be easily disengaged or released from the wall member.

The other objective of the present invention is to provide a door retaining device for releaseably attaching or anchoring or positioning the door panel to the wall member without bending down their bodies to hook or to engage the latch with the hook member or without hand contacting or engaging with the latch.

In accordance with one aspect of the invention, there is provided a door retaining device comprising a hook member, a housing, a latch rotatably engaged and attached to the housing, and a rotating device for rotating the latch relative to the housing to actuate the latch to selectively engage with the hook member and to stably anchor and secure the hook member to the housing when the hook member is moved toward and depressed against the housing, or to selectively disengage the latch from the hook member and to position the latch in disengagement from the hook member when the hook member is moved toward and depressed against the housing again, such that the latch may be easily actuated to engage with the hook member and to stably anchor and secure the hook member to the housing without hand contacting or engaging with the latch, such that the users are not required to bend down their bodies and then to hook or to engage the latch with the hook member by themselves.

The rotating device includes a stem slidably received in the housing and coupled to the latch for rotating the latch relative to the housing when the stem is slid and moved relative to the housing. The latch includes a cam member provided thereon and rotatably coupled to the stem for allowing the latch to be rotated relative to the housing by the stem. The stem includes a coupler for rotatably receiving the cam member of the latch and thus for allowing the cam member to be rotatably coupled to the stem.

The rotating device includes device for biasing the stem to slide and to move relative to the housing and to selectively actuate the latch to engage with the hook member. The housing includes at least one partition provided therein and having a channel formed therein to slidably receive the stem therein. The housing includes a groove formed therein, and the latch includes a shaft rotatably engaged in the groove of the housing for rotatably attaching and securing the latch to the housing.

The rotating device includes a shank slidably received in the housing and having at least one actuator extended therefrom, and a control device rotatably engaged onto the stem and having at least one protrusion provided thereon to form at least one slit and at least one seat therein, and the housing includes at least one rib provided therein to selectively engage with the either the slit or the seat of the control device.

The protrusion of the control device includes an inclined surface formed thereon for slidably engaging with the actuator of the shank and for allowing the- control device to be rotated relative to the housing and the stem by the shank. The shank includes an end cap attached thereto for engaging with the hook member. The shank includes a bore formed therein and the end cap includes a stud extended therein and engaged into the bore of the shank to attach the end cap to the shank.

The housing includes a first housing member and a second housing member secured together. The housing members of the housing each includes a partition extended therein and engaged with each other to secure the housing members together. The first housing member of the housing includes at least one cavity formed therein and the second housing member includes at least one peg extended therefrom for engaging into the cavity of the first housing member and for anchoring the housing members together.

The housing members of the housing include a reduced peripheral shoulder formed therein and a clamping ring engaged onto the reduced peripheral shoulder of the housing to solidly secure the housing members together. The housing includes a plate for securing to an object, and the housing includes a base engaged onto the plate and secured to the plate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a door retaining device in accordance with the present invention;

FIG. 2 is a front perspective view of the door retaining device;

FIG. 3 is a partial rear perspective view of the door retaining device;

FIG. 4 is an end view illustrating a control device of the door retaining device;

FIG. 5 is a plan view of the control device of the door retaining device;

FIG. 6 is a rear perspective view illustrating an end cap of the door retaining device;

FIG. 7 is a partial plan view illustrating the operation of the door retaining device;

FIGS. 8 and 9 are partial plan views similar to FIG. 7, illustrating the operation of the door retaining device;

FIG. 10 is an enlarged partial cross sectional view of the door retaining device, taken along lines 10-10 of FIG. 7; and

FIGS. 11 and 12 are enlarged partial cross sectional views similar to FIG. 10, illustrating the operation of the door retaining device.

### DETAILED DESCRIPTION OF THE PREFERRED EMBODIMENT

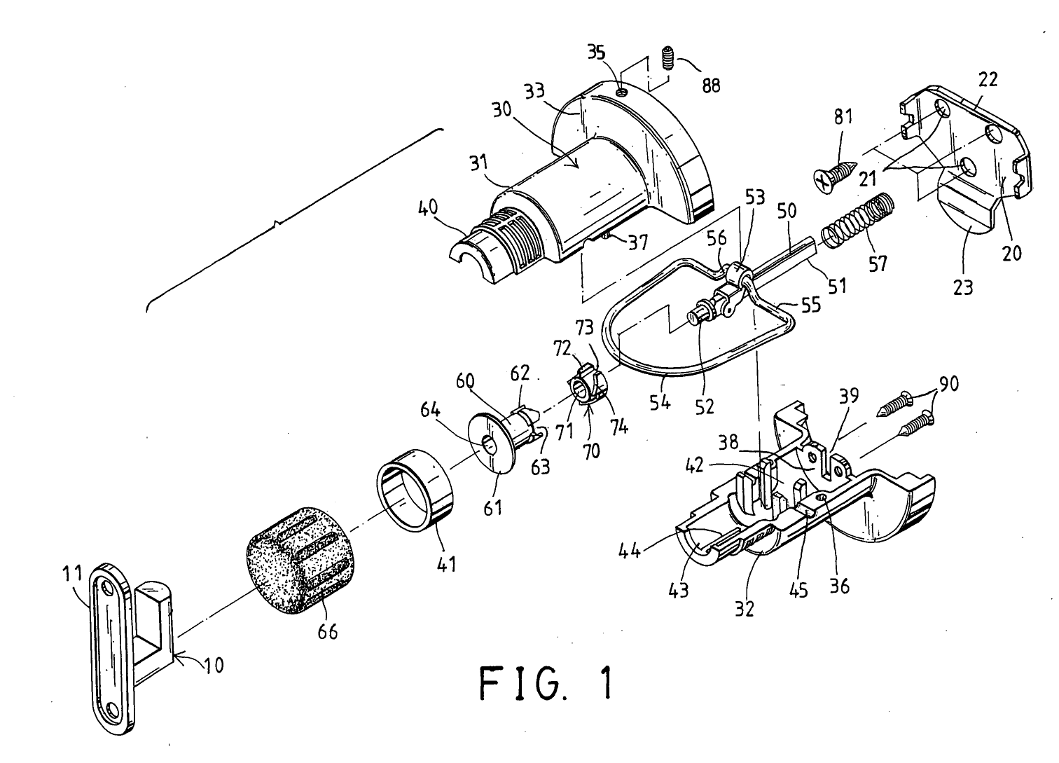

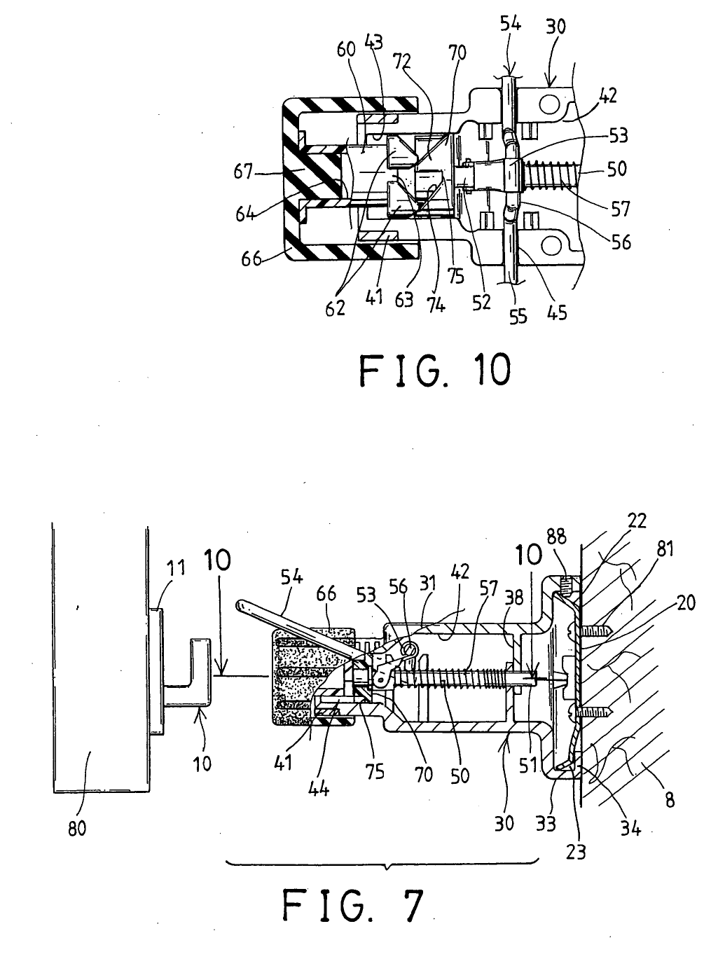

Referring to the drawings, and initially to FIGS. 1 and 7-9, a door retaining device in accordance with the present invention comprises a hook member 10 including a seat 11 for securing to an object 80, such as a wall member 8 or a door panel 80 (FIGS. 7-9) with such as latches or fasteners (not shown), and a housing 30 for securing to the other object 8 such as the door panel 80 or the wall member 8 with such as latches or fasteners 81 (FIGS. 1, 3, 7). For example, a plate 20 includes one or more holes 21 formed therein for receiving the fasteners 81 which may secure the plate 20 to the door panel 80 or the wall member 8. The plate 20 includes a lip 22 formed or provided on the upper portion thereof, and a tongue 23 extended downwardly therefrom.

The housing 30 may include two housing members 31, 32 secured together, and may include an enlarged base 33 for engaging onto the plate 20, and includes an anchor flap 34 extended into one of the housing members or the lower housing member 32 (FIGS. 3, 7) for engaging with the tongue 23 of the plate 20, and includes a screw hole 35 formed in the other or the upper housing member 31 (FIG. 1) for receiving a fastener or securing member 88 which may be threaded into the base 33 of the housing members 32 or of the housing 30 and which may be engaged with the lip 22 of the plate 20, for solidly securing the housing 30 to the plate 20 and thus to the door panel 80 or the wall member 8.

The lower housing member 32 may include one or more cavities 36 formed therein (FIG. 1), and the upper housing member 31 may include one or more pegs 37 extended therefrom for engaging into the corresponding cavities 36 of the lower housing member 32 and for anchoring the housing members 31, 32 together and for preventing the housing members 31, 32 from being moved or shifted relative to each other. The housing members 31, 32 each further includes a partition 38 extended therein and the partitions 38 may be engaged with each other (FIG. 7) and secured together with such as fasteners 90 (FIG. 1) for further solidly securing the housing members 31, 32 together.

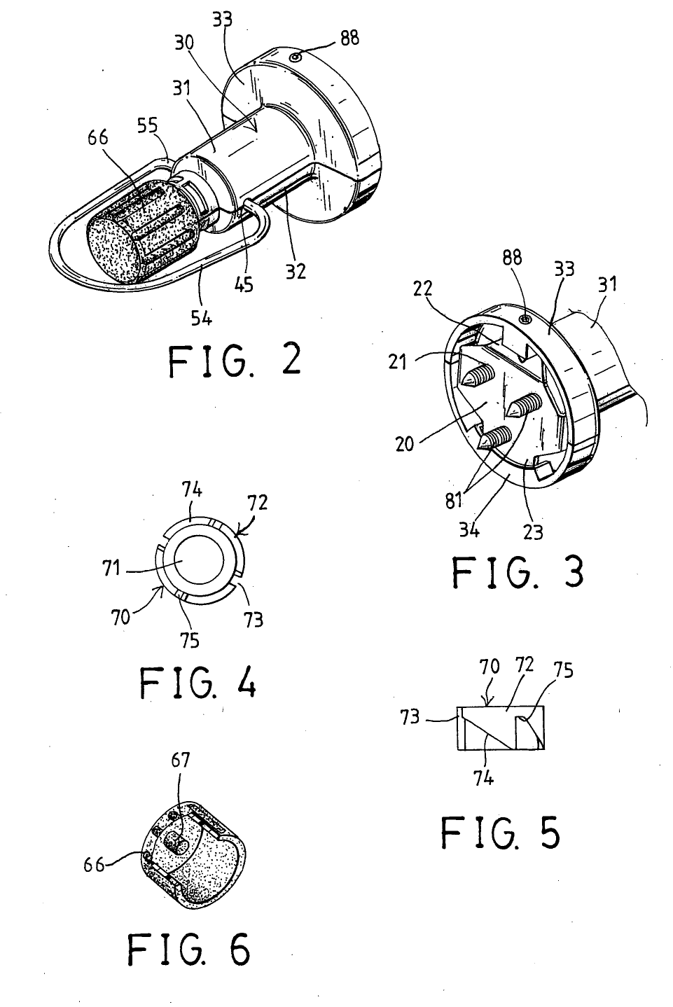

One or both of the partitions 38 may include a channel 39 formed therein and aligned with each other. The housing 30 includes a reduced neck portion or peripheral shoulder 40 formed in the front portion thereof, and a retaining or clamping ring 41 is engaged onto the reduced neck portion or peripheral shoulder 40 of the housing 30 (FIGS. 10-12) for further solidly securing the housing members 31, 32 together. The housing 30 includes a chamber 42 formed in the middle portion thereof and a relatively reduced passage 43 formed in the front portion thereof, and includes one or more, such as two guide ribs 44 extended in such as the passage 43 thereof (FIGS. 1 and 7-9), and includes a groove 45 laterally formed therein (FIGS. 1-2 and 10-12).

A stem 50 is slidably received in the chamber 42 of the housing 30 and includes a rear portion 51 slidably received or engaged in the channel 39 of the partitions 38 of the housing 30 and may include a front portion 52, and may include a coupler 53 formed or provided thereon. A ring-shaped latch 54 includes a shaft 55 rotatably engaged in the groove 45 of the housing 30 for rotatably attaching or securing the latch 54 to the housing 30, and includes a bent or cam member 56 provided thereon and rotatably engaged into or with the coupler 53 of the stem 50 for allowing the latch 54 to be rotated relative to the housing 30 by the stem 50.

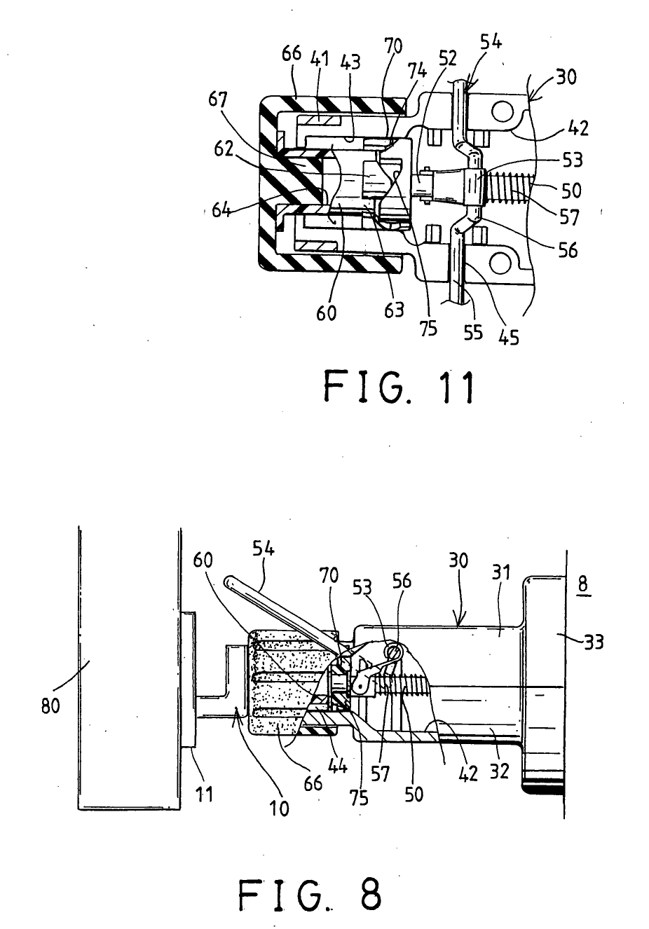

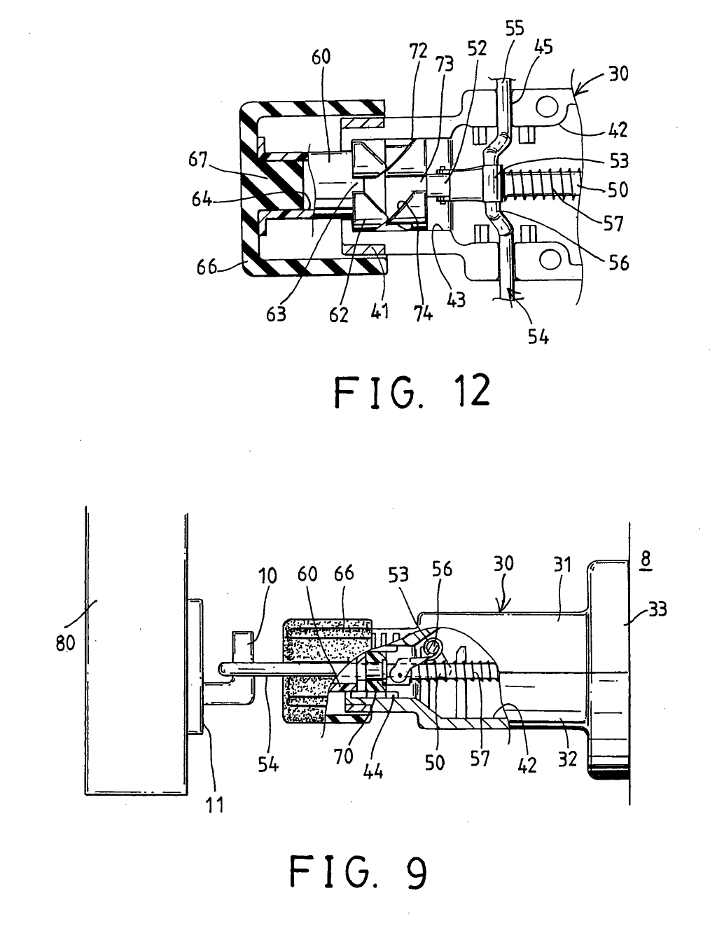

For example, the latch 54 may be rotated relative to the housing 30 and disengaged from the hook member 10 (FIGS. 7, 8) when the stem 50 is slid or moved away from the hook member 10 or moved toward the plate 20 (FIGS. 10, 11); and may also be rotated relative to the housing 30 to engage with the hook member 10 (FIG. 9) when the stem 50 is slid or moved toward the hook member 10 or moved away from the plate 20 (FIG. 12). A spring member 57 may be engaged onto the stem 50 and engaged with the coupler 53 of the stem 50 and the partitions 38 of the housing 30, for biasing the stem 50 to actuate the latch 54 to engage with the hook member 10 (FIG. 9).

A shank 60 is slidably received in the passage 43 of the housing 30 and includes an enlarged head 61 provided or extended out of the housing 30 and engageable with the housing 30 for limiting the shank 60 to slide or to move relative to the housing 30 and for preventing the shank 60 from being completely engaged into the housing 30, and includes one or more blocks or actuators 62 and one or more slots 63 formed therein and slidably engaging with the guide ribs 44 of the housing 30, for guiding the shank 60 to slide or to move relative to the housing 30 and for preventing the shank 60 from being rotated relative to the housing 30.

As shown in FIGS. 1, 4-5 and 10-12, a control device 70 includes a bore 71 formed therein for rotatably and slidably engaged onto the front portion 52 of the stem 50 and includes one or more protrusions 72 formed on the outer peripheral portion thereof and one or more slits 73 and one or more seats 75 alternatively formed in the outer peripheral portion thereof and defined between or by the protrusions 72 for slidably engaging with the guide ribs 44 of the housing 30 alternatively. Each of the protrusions 72 preferably includes an inclined surface 74 formed thereon for slidably engaging with the actuators 62 of the shank 60 (FIGS. 10-12), and for allowing the control device 70 to be rotated relative to the housing 30 and the stem 50 by the shank 60.

It is to be noted that the slits 73 of the control device 70 are opened or formed through the protrusions 72 to allow the guide ribs 44 of the housing 30 to be completely moved or engaged through the slits 73 of the control device 70 (FIG. 9), and to allow the stem 50 to be biased by the spring member 57 to actuate the latch 54 to engage with the hook member 10. On the contrary, the seats 75 of the control device 70 may be engaged with and seated on the guide ribs 44 of the housing 30 (FIGS. 7, 8) to prevent the guide ribs 44 of the housing 30 from completely moving or engaging through the slits 73 of the control device 70, and thus to prevent the stem 50 from being biased by the spring member 57 to actuate the latch 54 to engage with the hook member 10, and in order to retain or to position the latch 54 in disengagement from the hook member 10 and the door panel 80.

An end cap 66 may further be provided and slidably engaged onto the retaining or clamping ring 41 and/or the front portion of the housing 30, and includes a stud 67 extended therein (FIG. 6) and engaged into a bore 64 of the shank 60 (FIGS. 10-12) to allow the end cap 66 to be moved in concert with the shank 60. The end cap 66 is preferably made of soft or rubber or resilient materials for selectively engaging with the hook member 10 (FIG. 8) and for allowing the shank 60 and thus the stem 50 to be moved into the housing 30 against the spring member 57. The shank 60 may also be directly engaged with the hook member 10 without attaching the end cap 66.

In operation, as shown in FIG. 7, at the beginning, the seats 75 of the control device 70 may be engaged with and seated on the guide ribs 44 of the housing 30 to prevent the guide ribs 44 of the housing 30 from completely moving or engaging through the slits 73 of the control device 70, and thus to prevent the stem 50 from being biased by the spring member 57 to actuate the latch 54 to engage with the hook member 10, and to retain or to position the latch 54 in disengagement from the hook member 10, and thus to allow the hook member 10 and/or the door panel 80 to be moved toward and to engage with the end cap 66 in order to move the shank 60 and the stem 50 into the housing 30 against the spring member 57.

When the shank 60 is forced to move into the housing 30, the actuators 62 of the shank 60 may be slidably engaged with the inclined surfaces 74 of the protrusions 72 of the control device 70 in order to rotate the control device 70 relative to the housing 30 and the stem 50, and thus to allow the alternate slit 73 of the control device 70 to be aligned with the guide ribs 44 of the housing 30 and to allow the guide ribs 44 to be completely moved or engaged through the slits 73 of the control device 70 and thus to allow the stem 50 to be biased by the spring member 57 to actuate the latch 54 to engage with the hook member 10 (FIG. 9), such that the door panel 80 may be stably anchored and secured or coupled to the wall member 8.

When the door panel 80 is moved toward and to engage with the end cap 66 again, the shank 60 and the stem 50 may also be moved into the housing 30 against the spring member 57, the actuators 62 of the shank 60 may also be slidably engaged with the inclined surfaces 74 of the protrusions 72 of the control device 70 to rotate the control device 70 relative to the housing 30 and the stem 50, and thus to allow the alternate seat 72 of the control device 70 to be aligned with and to be engaged with and seated on the guide ribs 44 of the housing 30, and to prevent the guide ribs 44 of the housing 30 from completely moving or engaging through the slits 73 of the control device 70, and thus to prevent the stem 50 from being biased by the spring member 57 to actuate the latch 54 to engage with the hook member 10, and to retain or to position the latch 54 in disengagement from the hook member 10 again.

Accordingly, in operation, the user is simply required to move the door panel 80 toward the wall member 8 and to force or depress the hook member 10 against the end cap 66 and the shank 60 and the stem 50 and the spring member 57 and thus to actuate the latch 54 to engage with the hook member 10 (FIG. 9) and to allow the door panel 80 to be stably anchored and secured or coupled to the wall member 8. The user is also simply required to move the door panel 80 toward the wall member 8 and to force or depress the hook member 10 against the end cap 66 and the shank 60 and the stem 50 and the spring member 57 again, in order to actuate the latch 54 to be disengaged from the hook member 10 (FIG. 9), such that the door panel 80 may be easily and readily and quickly anchored and secured to or disengaged from the wall member 8.

The stem 50 and/or the spring member 57 and/or the shank 60 and/or the control device 70 may thus be formed or acted as a rotating or actuating means or device for selectively rotating the latch 54 relative to the housing to actuate the latch 54 to engage with the hook member 10 and thus to stably anchor and secure or couple the hook member 10 and thus the door panel 80 to the housing 30 and the wall member 8 when the hook member 10 is moved toward and depressed against the housing 30, or to be disengaged from the hook member 10 and to retain or to position the latch 54 in disengagement from the hook member 10 when the hook member 10 is moved toward and depressed against the housing 30 again.

Accordingly, the door retaining device in accordance with the present invention may be provided for releasably attaching or anchoring or positioning a door panel to a wall member, and having a structure for allowing the door panel to be easily anchored or positioned to the wall member and to be easily disengaged or released from the wall member without bending down the users' bodies and without hand contacting or engaging with latches and hook members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door retaining device comprising:
a hook member,
a housing,
a latch rotatably engaged and attached to said housing, and
means for rotating said latch relative to said housing to actuate said latch to selectively engage with said hook member and to stably anchor and secure said hook member to said housing when said hook member is moved toward and depressed against said housing, or to selectively disengage said latch from said hook member and to position said latch in disengagement from said hook member when said hook member is moved toward and depressed against said housing again.

2. The door retaining device as claimed in claim 1, wherein said rotating means includes a stem slidably received in said housing and coupled to said latch for rotating said latch relative to said housing when said stem is slid and moved relative to said housing.

3. The door retaining device as claimed in claim 2, wherein said latch includes a cam member provided thereon and rotatably coupled to said stem for allowing said latch to be rotated relative to said housing by said stem.

4. The door retaining device as claimed in claim 3, wherein said stem includes a coupler for rotatably receiving said cam member of said latch.

5. The door retaining device as claimed in claim 2, wherein said rotating means includes means for biasing said stem to slide and to move relative to said housing and to selectively actuate said latch to engage with said hook member.

6. The door retaining device as claimed in claim 2, wherein said housing includes at least one partition provided therein and having a channel formed therein to slidably receive said stem therein.

7. The door retaining device as claimed in claim 2, wherein said housing includes a groove formed therein, and said latch includes a shaft rotatably engaged in said groove of said housing for rotatably attaching and securing said latch to said housing.

8. The door retaining device as claimed in claim 2, wherein said rotating means includes a shank slidably received in said housing and having at least one actuator extended therefrom, and a control device rotatably engaged onto said stem and having at least one protrusion provided thereon to form at least one slit and at least one seat therein, and said housing includes at least one rib provided therein to selectively engage with said either said at least one slit or said at least one seat of said control device.

9. The door retaining device as claimed in claim 8, wherein said at least one protrusion of said control device includes an inclined surface formed thereon for slidably engaging with said at least one actuator of said shank and for allowing said control device to be rotated relative to said housing and said stem by said shank.

10. The door retaining device as claimed in claim 8, wherein said shank includes an end cap attached thereto for engaging with said hook member.

11. The door retaining device as claimed in claim 10, wherein said shank includes a bore formed therein and said end cap includes a stud extended therein and engaged into said bore of said shank to attach said end cap to said shank.

12. The door retaining device as claimed in claim 1, wherein said housing includes a first housing member and a second housing member secured together.

13. The door retaining device as claimed in claim 12, wherein said first and said second housing members of said housing each includes a partition extended therein and engaged with each other to secure said first and said second housing members together.

14. The door retaining device as claimed in claim 12, wherein said first housing member of said housing includes at least one cavity formed therein and said second housing member includes at least one peg extended therefrom for engaging into said at least one cavity of said first housing member and for anchoring said first and said second housing members together.

15. The door retaining device as claimed in claim 12, wherein said first and said second housing members of said housing include a reduced peripheral shoulder formed therein and a clamping ring engaged onto said reduced peripheral shoulder of said housing to solidly secure said housing members together.

16. The door retaining device as claimed in claim 1, wherein said housing includes a plate for securing to an object, and said housing includes a base engaged onto said plate and secured to said plate.
